(19) United States
(12) Patent Application Publication
(10) Pub. No.: US 2010/0164981 A1
(43) Pub. Date: Jul. 1, 2010

(54) DATA COMPRESSION METHOD AND APPARATUS FOR IMAGE DISPLAY BASED ON OVERDRIVE PROCESSING

(76) Inventor: Ming-Hsun LU, Taipei County (TW)

Correspondence Address: Muncy, Geissler, Olds & Lowe, PLLC, 4000 Legato Road, Suite 310, FAIRFAX, VA, 22033, US

(21) Appl. No.: 12/650,358

(22) Filed: Dec. 30, 2009

(30) Foreign Application Priority Data
Dec. 30, 2008 (TW) 097151368

(51) Int. Cl. G06K 9/36; G09G 5/02

(52) U.S. Cl. 345/604; 382/166

(57) ABSTRACT

A data compression method and apparatus for image display based on overdrive processing is disclosed. An original image data is provided. The original image data is transformed from an RGB encoded format to a YUV encoded format. The transformation is compressed as the original image data with the YUV encoded format. The compressed original image data is written in a storage medium using a predefined method. The compressed original image data is decompressed. The original image data is transformed from the YUV encoded format to the RGB encoded format. The original image data is outputted to a display device using a driving unit.

### CROSS REFERENCE TO RELATED APPLICATIONS

This Application claims priority of Taiwan Patent Application No. 097151368, filed on Dec. 30, 2008, the entirety of which is incorporated by reference herein.

### BACKGROUND OF THE INVENTION

### 1. Field of the Invention

The invention relates to a method for clearing blur images of a monitor, and more particularly to a data compression method and apparatus for image display based on overdrive processing.

2. Description of the Related Art

With respect to traditional liquid crystal display (LCD) monitors, since dynamic display technology cannot immediately update past frames with new frames, blur images may occur when dynamic images are displayed, resulting from insufficient reaction time of an image driving device. Generally, such problems can be solved by raising driving voltage (i.e. using the overdrive (OD) technology) so reaction time of displaying dynamic images can be effectively increased, wherein image frequency is reduced from 16.7 milliseconds (ms) to 5 ms or even 3 ms. However, blur images for dynamic images may still be viewed by human vision.

As described when the image frame of the LCD changes, the overdrive technology applies greater voltage to enhance reaction time of liquid crystal molecules of the LCD, so that at least half of a reaction time, can be reduced. Generally, reaction time of liquid crystal molecules is about 16˜40 milliseconds (ms) and may be changed to 3˜8 ms when overdrive technology is implemented.

To substantially improve blur images, reaction time, and smooth representation of image frames and provide colorful and vivid image quality based on the overdrive technology, the invention provides a data compression method and apparatus for image display based on overdrive processing.

### BRIEF SUMMARY OF THE INVENTION

Methods for clearing blur images of a monitor are provided. An exemplary embodiment of a method for clearing blur images of a monitor comprises the following. An original image data is provided. The original image data is transformed from an RGB encoded format to a YUV encoded format. The transformation is compressed as the original image data with the YUV encoded format. The compressed original image data is written in a storage medium using a predefined method. The compressed original image data is decompressed. The original image data is transformed from the YUV encoded format to the RGB encoded format. The original image data is outputted to a display device using a driving unit.

Data compression apparatuses for image display based on overdrive processing are provided. An exemplary embodiment of a data compression apparatus for image display based on overdrive processing comprises a storage medium, an RGB-to-YUV transformation unit, an image compression unit, an image decompression unit, a YUV-to-RGB transformation unit, a motion detection unit, a speed-up driving and processing unit, and a multiplexer. The RGB-to-YUV transformation unit transforms the image data from an RGB encoded format to a YUV encoded format. The image compression unit compresses the transformed image data as the image data with the YUV encoded format and writes the compressed image data in a storage medium using a predefined method. The image decompression unit decompresses the compressed image data. The YUV-to-RGB transformation unit transforms the image data from the YUV encoded format to the RGB encoded format. The motion detection unit determines whether implementing acceleration to the image data with the RGB encoded format is required. The speed-up driving and processing unit accelerates the image data with the RGB encoded format if acceleration is required. The multiplexer outputs the image data to a display device.

The invention further provides a computer-readable medium encoded with computer executable instructions for performing a data compression method for image display based on overdrive processing. The computer executable instructions comprises providing an original image data, transforming the original image data from an RGB encoded format to a YUV encoded format, compressing the transformed image data as the image data with the YUV encoded format, writing the compressed image data in a storage medium using a predefined method, decompressing the compressed image data, transforming the image data from the YUV encoded format to the RGB encoded format, and outputting the image data to a display device using a driving unit.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a data compression apparatus for image display based on overdrive processing of the present invention.

FIG. 2 is a schematic view of a compression mechanism of the present invention.

FIG. 3 is a flowchart of a data compression method for image display based on overdrive processing of the present invention.

### DETAILED DESCRIPTION OF THE INVENTION

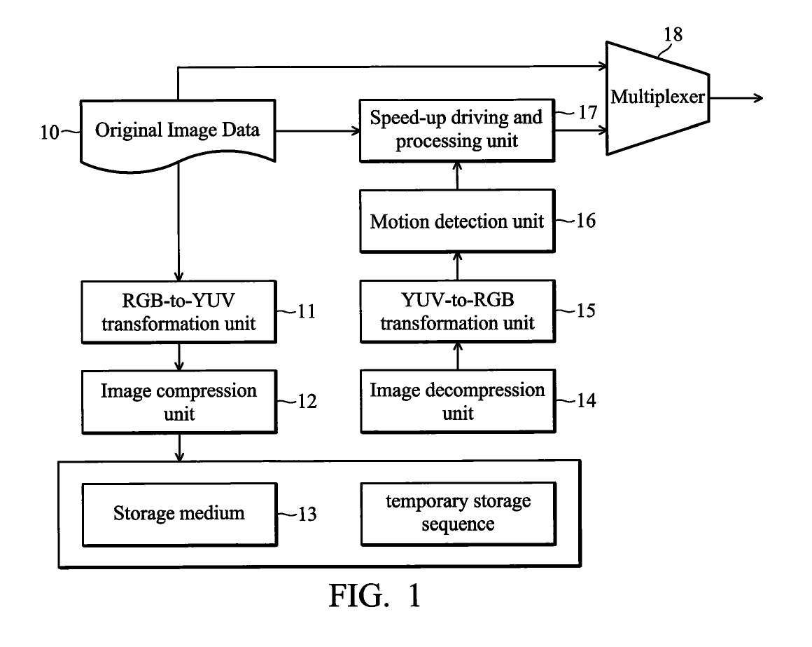

Several exemplary embodiments of the invention are described with reference to FIGS. 1 through 4, which generally relate to clearing blur images of a monitor. It is to be understood that the following disclosure provides various different embodiments as examples for implementing different features of the invention. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

The invention discloses a data compression method and apparatus for image display based on overdrive processing.

An embodiment of the data compression method and apparatus for image display based on overdrive processing respectively implements different processes to even serial data and odd serial data of an input image, thus accelerating writing of input image in a storage medium and accessing the input image from the storage medium.

FIG. 1 is a schematic view of a data compression apparatus for image display based on overdrive processing of the present invention.

As shown in FIG. 1, the data compression apparatus for image display based on overdrive processing comprises an RGB-to-YUV transformation unit 11, an image compression unit 12, a storage medium 13, an image decompression unit 14, a YUV-to-RGB transformation unit 15, a motion detection unit 16, a speed-up driving and processing unit 17, and a multiplexer 18. The storage medium 13 may be a Random Access Memory (RAM) or a Synchronous Dynamic Random Access Memory (SDRAM).

The data compression apparatus for image display based on overdrive processing first retrieves original image data 10. The original image data 10 can be divided into even serial data and odd serial data. The original image data 10 is input in the RGB-to-YUV transformation unit 11 to be transformed to YUV image data. The transformed image data 10 is compressed using the image compression unit 12, and the compressed image data 10 is stored in the storage medium 13 using a predefined method.

The compressed image data 10 is accessed from the storage medium 13 to be decompressed using the image decompression unit 14. When decompression has been completed, the decompressed image data 10 is transformed to RGB image data using the YUV-to-RGB transformation unit 15. The motion detection unit 16 determines whether implementing acceleration to the transformed image data 10 is required. If required, the speed-up driving and processing unit 17 accelerates the transformed image data 10 and outputs the accelerated image data 10 to the multiplexer 17 and the multiplexer 17 outputs the accelerated image data 10 to a display device (not shown).

As described, to accelerate writing of image data in the storage medium 13 and accessing the image data from the storage medium 13, different processes are respectively implemented to even serial data and odd serial data of the input image.

With respect to the processes related to the odd serial data of the input image:

1. Input pixel data (with the RGB encoded format, numbered by NF_PL_RGB) of the input image (a frame, for example) is stored in a first temporary storage sequence (Line_Buf1, at least comprising i_buf1_1, i_buf1_2, and i_buf1_3) (not shown);

2. Compressed image data of the previous image (numbered by PF_COMP) is accessed from the storage medium 13 and stored in a second temporary storage sequence (Line_Buf2, at least comprising i_buf2_1 and i_buf2_2) (not shown); and

3. The input pixel data of the input image (with the RGB encoded format, numbered by NF_PL_RGB) stored in a third temporary storage sequence (not shown) is accessed and output.

With respect to the processes related to the even serial data of the input image:

1. Input pixel data (with the RGB encoded format, numbered by NF_PL_RGB) of the input image stored in the first temporary storage sequence (Line_Buf1) and input serial data (numbered by NF_NL_RGB) are accessed and transformed to the YUV encoded format (numbered by NF_PL_YUV and NF_NL_YUV);

2. The transformed image data is compressed from 24-bit to 16-bit and the compressed image data (numbered by NF_COMP) is stored in the storage medium 13;

3. Image data (numbered by PF_COMP) stored in the second temporary storage sequence is accessed and compared with image data (numbered by NF_COMP) transformed as the compressed YUV encoded format;

4. The PF_COMP image data is decompressed to obtain the PF_PL_YUV image data and PF_NL_YUV image data and transformed to the RGB encoded format to obtain the PF_PL_RGB image data and the PF_NL_RGB image data;

5. The PF_PL_RGB image data and the NF_PL_RGB image data are compared using a lookup table to obtain a speed-up driving and processing value of PL (OVER_PL) while the PF_NL_RGB image data and the NF_NL_RGB image data are compared using the lookup table to obtain a speed-up driving and processing value of NL (OVER_NL);

6. The PF_COMP is subtract from the NF_PL_RGB to obtain a value J; and

7. If J is greater than a predetermined value, the image data is accelerated and the OVER_PL is output and the OVER_NL is stored in the third temporary storage sequence (Line_Buf3, at least comprising i_buf3_1, i_buf3_2, and i_buf3_3) (not shown), and, if J is less than the predetermined value, the NF_PL_RGB image data is output and the NF_NL_RGB image data is stored in the third temporary storage sequence (Line_Buf3) (not shown).

As described, a transformation equation for transforming the RGB encoded format to the YUV encoded format is represented as follows:

Y=0.299R+0.587G+0.114B;

U=(−0.172)R+(−0.339)G+0.511B+128; and

V=0.511R+(−0.428)G+(−0.083)B+128.

A transformation equation for transforming the YUV encoded format to the RGB encoded format is represented as follows:

R=Y+1.371V;

G=Y+(−0.336)(U−128)+(−0.0698)(V−128); and

B=Y+1.732U.

With respect to image compression, an algorithm is used and described in the following.

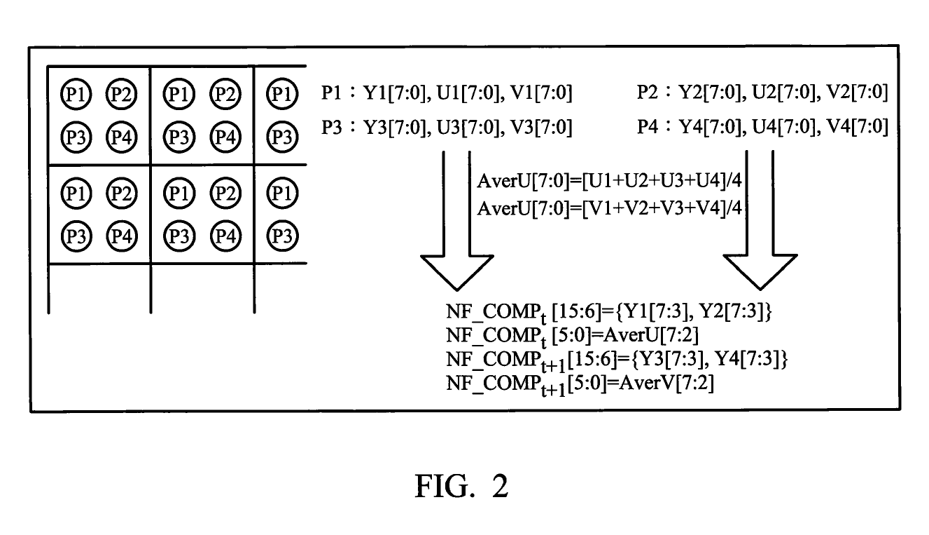

FIG. 2 is a schematic view of a compression mechanism of the present invention.

Referring to FIG. 2, regional data of the input image is first divided to 2×2 regional pixel data. Since bandwidth of a data bus of the storage medium 13 only provides 16 bits and the amount of the pixel data which should be simultaneously processed is 48 bits, a trade off operation must be performed, such that a portion of image information may be lost but image characteristics of original pixels would not be lost. Additionally, with respect to general dynamic images, the UV signals (chrominance signals) do not substantially change such that an average value of the UV signals can be taken and more Y signals (luminance signals) can be reserved.

With respect to the image decompression, the compressed image data is expanded to the 8-bit format, comprising:

PF_Y1[7:0]={PF_COMPₜ[15:11], PF_COMPₜ[15:13]};

PF_Y2[7:0]={PF_COMPₜ[10:6], PF_COMPₜ[10:8]};

PF_{—}Y3[7:0]=PF_COMPₜ+1[15:11], PF_COMPₜ+1[15:13]};

PF_{—}Y4[7:0]={PF_COMPₜ+1[10:6], PF_COMPₜ+1[10:8]};

PF_U1[7:0]={PF_COMPₜ[5:0], PF_COMPₜ[5:4]}=PF_U2=PF_U3=PF_U4; and

PF_V1[7:0]={PF_COMPₜ+1[5:0], PF_COMPₜ+1[5:4]}=PF_{—}V2=PF_{—}V3=PF_{—}V4.

With respect to the motion detection, the PF_COMP is compared with the NF_COMP. When the difference is greater than a predetermined value, pixel data is accelerated and a speed-up driving and processing value is output. When the difference is less than the predetermined value, pixel data is directly output.

With respect to the speed-up driving and processing, the method of the invention uses a look-up table and two-dimensional interpolation to achieve acceleration. The look-up table is shown as:

| Cur- | | | | | | | | | | | |
|---|---|---|---|---|---|---|---|---|---|---|---|
| rent | Previous Pixel | | | | | | | | | | |
| Pixel | 0 | 32 | 64 | 96 | 128 | 160 | 192 | 208 | 224 | 240 | 255 |
| 0 | 0 | 0 | 0 | 0 | 0 | 0 | 0 | 0 | 0 | 0 | 0 |
| 32 | LUT_01 | 32 | LUT_21 | LUT_31 | LUT_41 | LUT_51 | LUT_61 | X | LUT_81 | LUT_91 | LUT_A1 |
| 64 | LUT_02 | LUT_12 | 64 | LUT_32 | LUT_42 | LUT_52 | LUT_62 | X | LUT_82 | LUT_92 | LUT_A2 |
| 96 | LUT_03 | LUT_13 | LUT_23 | 96 | LUT_43 | LUT_53 | LUT_63 | X | LUT_83 | LUT_93 | LUT_A3 |
| 128 | LUT_04 | LUT_14 | LUT_24 | LUT_34 | 128 | LUT_54 | LUT_64 | X | LUT_84 | LUT_94 | LUT_A4 |
| 160 | LUT_05 | LUT_15 | LUT_24 | LUT_35 | LUT_45 | 160 | LUT_65 | X | LUT_85 | LUT_95 | LUT_A5 |
| 192 | LUT_06 | LUT_16 | LUT_25 | LUT_36 | LUT_46 | LUT_56 | 192 | LUT_76 | LUT_86 | LUT_96 | LUT_A6 |
| 208 | X | X | X | X | X | X | LUT_67 | 208 | LUT_87 | LUT_97 | LUT_A7 |
| 224 | LUT_08 | LUT_18 | LUT_28 | LUT_38 | LUT_48 | LUT_58 | LUT_68 | LUT_78 | 224 | LUT_98 | LUT_A8 |
| 240 | X | X | X | X | X | X | LUT_69 | LUT_79 | LUT_89 | 240 | LUT_A9 |
| 255 | 255 | 255 | 255 | 255 | 255 | 255 | 255 | 255 | 255 | 255 | 255 |

Note that, in other embodiments, at least three look-up tables can be retrieved from an external Electrically Erasable Programmable Read-Only Memory (EEPROM) and a desired table is selected according to different conditions. As the look-up table describes, four boundary values are located according to previous pixel data and current pixel data and required speed-up driving and processing data is obtained based on the four boundary values using the two-dimensional interpolation. The described process can be implemented using multiple multiplexers.

The storage operations are performed using the storage medium 13 and at least the three temporary storage sequences so that the method and apparatus of the invention can rapidly process image information and display the image information on a LCD monitor via the speed-up driving and processing unit 17, efficiently clearing blur images of the LCD monitor.

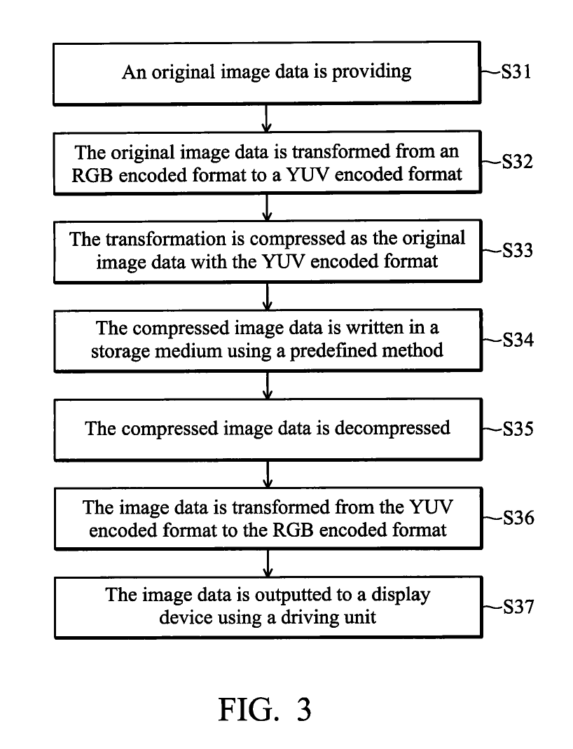

FIG. 3 is a flowchart of a data compression method for image display based on overdrive processing of the present invention.

An original image data is providing (step S31). The original image data is transformed from an RGB encoded format to a YUV encoded format (step S32). The transformation is compressed as the original image data with the YUV encoded format (step S33). The compressed image data is written in a storage medium using a predefined method (step S34). The compressed image data is decompressed (step S35). The image data is transformed from the YUV encoded format to the RGB encoded format (step S36). The image data is outputted to a display device using a driving unit (step S37). The predefined method is to implement different processes to even serial data and odd serial data of an input image, as described.

The data compression method for image display based on overdrive processing further respectively implements different processes to even serial data and odd serial data of the image data.

The processing for the odd serial data comprises: storing input pixel data with the RGB encoded format of the input in a first temporary storage sequence; accessing compressed image data of the previous image (represented by PF_COMP) from the storage medium and storing the compressed image data (PF_COMP) in a second temporary storage sequence; and accessing and outputting the input pixel data of the input image with the RGB encoded format (represented by NF_PL_RGB) stored in a third temporary storage sequence.

The processing for the even serial data comprises: accessing and transforming the input pixel data with the RGB encoded format (NF_PL_RGB) of the input image stored in the first temporary storage sequence and input serial data (represented by NF_NL_RGB) to the YUV encoded format (represented by NF_PL_YUV and NF_NL_YUV); compressing the transformed image data and storing the compressed image data (represented by NF_COMP) in the storage medium; accessing and comparing the image data (PF_COMP) stored in the second temporary storage sequence with the image data (NF_COMP) transformed as the compressed YUV encoded format; decompressing the PF_COMP image data to obtain the PF_PL_YUV image data and PF_NL_YUV image data and transforming the PF_COMP image data to the RGB encoded format to obtain the PF_PL_RGB image data and the PF_NL_RGB image data; comparing the PF_PL_RGB image data and the NF_PL_RGB image data using a lookup table to obtain a first speed-up driving and processing value (represented by OVER_PL) and comparing the PF_NL_RGB image data and the NF_NL_RGB image data using the lookup table to obtain a second speed-up driving and processing value (represented by OVER_NL); subtracting the PF_COMP from the NF_PL_RGB to obtain a value J; accelerating the PF_PL_RGB image data and the NF_PL_RGB image data and outputting the OVER_PL, if J is greater than a predetermined value, and storing the OVER_NL value in the third temporary storage sequence; and outputting the NF_PL_RGB image data and storing the NF_NL_RGB image data in the third temporary storage sequence if J is less than the predetermined value.

The invention additionally discloses a computer-readable medium encoded with computer executable instructions for performing a data compression method for image display based on overdrive processing. The computer executable instructions comprises providing an original image data, transforming the original image data from an RGB encoded format to a YUV encoded format, compressing the transformed image data as the image data with the YUV encoded format, writing the compressed image data in a storage medium using a predefined method, decompressing the compressed image data, transforming the image data from the YUV encoded format to the RGB encoded format, and outputting the image data to a display device using a driving unit.

The computer executable instructions further respectively implements different processes to even serial data and odd serial data of the image data.

The computer executable instructions for the odd serial data comprises: storing input pixel data with the RGB encoded format of the input in a first temporary storage sequence; accessing compressed image data of the previous image (represented by PF_COMP) from the storage medium and storing the compressed image data (PF_COMP) in a second temporary storage sequence; and accessing and outputting the input pixel data of the input image with the RGB encoded format (represented by NF_PL_RGB) stored in a third temporary storage sequence.

The computer executable instructions for the even serial data comprises: accessing and transforming the input pixel data with the RGB encoded format (NF_PL_RGB) of the input image stored in the first temporary storage sequence and input serial data (represented by NF_NL_RGB) to the YUV encoded format (represented by NF_PL_YUV and NF_NL_YUV); compressing the transformed image data and storing the compressed image data (represented by NF_COMP) in the storage medium; accessing and comparing the image data (PF_COMP) stored in the second temporary storage sequence with the image data (NF_COMP) transformed as the compressed YUV encoded format; decompressing the PF_COMP image data to obtain the PF_PL_YUV image data and PF_NL_YUV image data and transforming the PF_COMP image data to the RGB encoded format to obtain the PF_PL_RGB image data and the PF_NL_RGB image data; comparing the PF_PL_RGB image data and the NF_PL_RGB image data using a lookup table to obtain a first speed-up driving and processing value (represented by OVER_PL) and comparing the PF_NL_RGB image data and the NF_NL_RGB image data using the lookup table to obtain a second speed-up driving and processing value (represented by OVER_NL); subtracting the PF_COMP from the NF_PL_RGB to obtain a value J; accelerating the PF_PL_RGB image data and the NF_PL_RGB image data and outputting the OVER_PL, if J is greater than a predetermined value, and storing the OVER_NL value in the third temporary storage sequence; and outputting the NF_PL_RGB image data and storing the NF_NL_RGB image data in the third temporary storage sequence if J is less than the predetermined value.

Methods and systems of the present disclosure, or certain aspects or portions of embodiments thereof, may take the form of a program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing embodiments of the disclosure. The methods and apparatus of the present disclosure may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data compression method for image display based on overdrive processing, comprising:
providing an original image data;
transforming the original image data from an RGB encoded format to a YUV encoded format;
compressing the transformed original image data with the YUV encoded format;
writing the compressed image data in a storage medium using a predefined method;
decompressing the compressed image data;
transforming the image data from the YUV encoded format to the RGB encoded format; and
outputting the image data to a display device using a driving unit.

2. The data compression method for image display based on overdrive processing as claimed in claim 1, wherein the predefined method is to implement different processes to even serial data and odd serial data of the input image.

3. The data compression method for image display based on overdrive processing as claimed in claim 2, wherein the processing for the odd serial data further comprises:
storing input pixel data with the RGB encoded format of the input in a first temporary storage sequence;
accessing compressed image data of the previous image (represented by PF_COMP) from the storage medium and storing the compressed image data (PF_COMP) in a second temporary storage sequence; and
accessing and outputting the input pixel data of the input image with the RGB encoded format (represented by NF_PL_RGB) stored in a third temporary storage sequence.

4. The data compression method for image display based on overdrive processing as claimed in claim 3, wherein the processing for the even serial data further comprises:
accessing and transforming the input pixel data with the RGB encoded format (NF_PL_RGB) of the input image stored in the first temporary storage sequence and input serial data (represented by NF_NL_RGB) to the YUV encoded format (represented by NF_PL_YUV and NF_NL_YUV);
compressing the transformed image data and storing the compressed image data (represented by NF_COMP) in the storage medium;
accessing and comparing the image data (PF_COMP) stored in the second temporary storage sequence with the image data (NF_COMP) transformed as the compressed YUV encoded format;
decompressing the PF_COMP image data to obtain the PF_PL_YUV image data and PF_NL_YUV image data and transforming the PF_COMP image data to the RGB encoded format to obtain the PF_PL_RGB image data and the PF_NL_RGB image data;
comparing the PF_PL_RGB image data and the NF_PL_RGB image data using a lookup table to obtain a first speed-up driving and processing value (represented by OVER_PL) and comparing the PF_NL_RGB image data and the NF_NL_RGB image data using the lookup table to obtain a second speed-up driving and processing value (represented by OVER_NL);
subtracting the PF_COMP from the NF_PL_RGB to obtain a value J;
accelerating the PF_PL_RGB image data and the NF_PL_RGB image data and outputting the OVER_PL, if J is greater than a predetermined value, and storing the OVER_NL value in the third temporary storage sequence; and
outputting the NF_PL_RGB image data and storing the NF_NL_RGB image data in the third temporary storage sequence if J is less than the predetermined value.

5. A data compression apparatus for image display based on overdrive processing, comprising:
a storage medium;
an RGB-to-YUV transformation unit transforming the image data from an RGB encoded format to a YUV encoded format;
an image compression unit compressing the transformed original image data with the YUV encoded format and writing the compressed image data in a storage medium using a predefined method;
an image decompression unit decompressing the compressed image data;
a YUV-to-RGB transformation unit transforming the image data from the YUV encoded format to the RGB encoded format;
a motion detection unit determining whether implementing acceleration to the image data with the RGB encoded format is required;
a speed-up driving and processing unit accelerating the image data with the RGB encoded format if acceleration is required; and
a multiplexer outputting the image data to a display device.

6. The data compression apparatus for image display based on overdrive processing as claimed in claim 5, wherein the predefined method is to implement different processes to even serial data and odd serial data of the input image.

7. The data compression apparatus for image display based on overdrive processing as claimed in claim 6, wherein the image compression unit for the odd serial data further stores input pixel data with the RGB encoded format of the input in a first temporary storage sequence, accesses compressed image data of the previous image (represented by PF_COMP) from the storage medium and stores the compressed image data (PF_COMP) in a second temporary storage sequence, and accesses and outputs the input pixel data of the input image with the RGB encoded format (represented by NF_PL_RGB) stored in a third temporary storage sequence.

8. The data compression apparatus for image display based on overdrive processing as claimed in claim 7, wherein the image compression unit for the even serial data further accesses and transforms the input pixel data with the RGB encoded format (NF_PL_RGB) of the input image stored in the first temporary storage sequence and input serial data (represented by NF_NL_RGB) to the YUV encoded format (represented by NF_PL_YUV and NF_NL_YUV), compresses the transformed image data and stores the compressed image data (represented by NF_COMP) in the storage medium, accesses and compares the image data (PF_COMP) stored in the second temporary storage sequence with the image data (NF_COMP) transformed as the compressed YUV encoded format, decompresses the PF_COMP image data to obtain the PF_PL_YUV image data and PF_NL_YUV image data and transforms the PF_COMP image data to the RGB encoded format to obtain the PF_PL_RGB image data and the PF_NL_RGB image data, compares the PF_PL_RGB image data and the NF_PL_RGB image data using a lookup table to obtain a first speed-up driving and processing value (represented by OVER_PL) and compares the PF_NL_RGB image data and the NF_NL_RGB image data using the lookup table to obtain a second speed-up driving and processing value (represented by OVER_NL), subtracts the PF_COMP from the NF_PL_RGB to obtain a value J, accelerates the PF_PL_RGB image data and the NF_PL_RGB image data and outputs the OVER_PL, if J is greater than a predetermined value, and stores the OVER_NL value in the third temporary storage sequence, and outputs the NF_PL_RGB image data and stores the NF_NL_RGB image data in the third temporary storage sequence if J is less than the predetermined value.

9. A computer-readable medium encoded with computer executable instructions for performing a data compression method for image display based on overdrive processing, wherein the computer executable instructions comprise:
providing an original image data;
transforming the original image data from an RGB encoded format to a YUV encoded format;
compressing the transformed image data with the YUV encoded format;
writing the compressed image data in a storage medium using a predefined method;
decompressing the compressed image data;
transforming the image data from the YUV encoded format to the RGB encoded format; and
outputting the image data to a display device using a driving unit.

10. The computer-readable medium as claimed in claim 9, wherein the predefined method is to implement different processes to even serial data and odd serial data of the input image.

11. The computer-readable medium as claimed in claim 10, wherein the processing for the odd serial data further comprises:
storing input pixel data with the RGB encoded format of the input in a first temporary storage sequence;
accessing compressed image data of the previous image (represented by PF_COMP) from the storage medium and storing the compressed image data (PF_COMP) in a second temporary storage sequence; and
accessing and outputting the input pixel data of the input image with the RGB encoded format (represented by NF_PL_RGB) stored in a third temporary storage sequence.

12. The computer-readable medium as claimed in claim 11, wherein the processing for the even serial data further comprises:
accessing and transforming the input pixel data with the RGB encoded format (NF_PL_RGB) of the input image stored in the first temporary storage sequence and input serial data (represented by NF_NL_RGB) to the YUV encoded format (represented by NF_PL_YUV and NF_NL_YUV);
compressing the transformed image data and storing the compressed image data (represented by NF_COMP) in the storage medium;
accessing and comparing the image data (PF_COMP) stored in the second temporary storage sequence with the image data (NF_COMP) transformed as the compressed YUV encoded format;
decompressing the PF_COMP image data to obtain the PF_PL_YUV image data and PF_NL_YUV image data and transforming the PF_COMP image data to the RGB encoded format to obtain the PF_PL_RGB image data and the PF_NL_RGB image data;
comparing the PF_PL_RGB image data and the NF_PL_RGB image data using a lookup table to obtain a first speed-up driving and processing value (represented by OVER_PL) and comparing the PF_NL_RGB image data and the NF_NL_RGB image data using the lookup table to obtain a second speed-up driving and processing value (represented by OVER_NL);
subtracting the PF_COMP from the NF_PL_RGB to obtain a value J;
accelerating the PF_PL_RGB image data and the NF_PL_RGB image data and outputting the OVER_PL, if J is greater than a predetermined value, and storing the OVER_NL value in the third temporary storage sequence; and
outputting the NF_PL_RGB image data and storing the NF_NL_RGB image data in the third temporary storage sequence if J is less than the predetermined value.
